(19) United States
(12) Patent Application Publication
(10) Pub. No.: US 2004/0199819 A1
(43) Pub. Date: Oct. 7, 2004

(54) Method for fast and local error correction in the event of the failure of individual physical corrections in bundled communication connections and communication system device for carrying out the method

(76) Inventors: Jorg Dauerer, Grobenzell (DE); Richard Waldhauser, Munchen (DE)

Correspondence Address: MORRISON & FOERSTER LLP, 1650 TYSONS BOULEVARD, SUITE 300, MCLEAN, VA, 22102, US

(21) Appl. No.: 10/486,558

(22) PCT Filed: Jul. 24, 2002
(86) PCT No.: PCT/EP02/08263

(30) Foreign Application Priority Data
Aug. 10, 2001 (DE) 101 39 385.7
Aug. 10, 2001 (EP) 01119365.3

(51) Int. Cl. H02H 3/05

(52) U.S. Cl. 714/25

(57) ABSTRACT

The invention relates to a method for detecting errors in communication connections having a plurality of physical connections (V1-V3) between two stations (BS or BSC). Data divided between at least two bundled physical connections (V1-V3) is transmitted, the individual connections being respectively monitored in the stations (BS or BSC) for errors. In the event of a connection error, the defective connection (V1) is deactivated. The aim of the invention is to enable an individual connection to be deactivated without large signalling costs and delays. To this end, the deactivation is autonomously carried out in relation to the two stations (BS or BSC), independently from each other and independently from other system devices.

### CLAIM FOR PRIORITY

This application claims priority to International Application No. PCT/EP02/08263, which was published in the German language on Jul. 24, 2002, which claims the benefit of priority to Germany Application No. DE 101 39 385.7 and European Application No. 01119365.3, which were filed in German and European languages on Aug. 10, 2001, respectively.

### TECHNICAL FIELD OF THE INVENTION

The invention relates to a system and method for fault rectification, and in particular, for fault rectification in the event of a failure of individual physical connections in communications connections having two or more physical connections between two stations.

### BACKGROUND OF THE INVENTION

In modern communications systems, for example the Internet or radio telecommunications systems such as GSM (Global System for Mobile Communication) or UMTS (Universal Mobile Telecommunications System), data and information are transmitted between individual stations via physical connections. Physical connections are, in this case, cable interfaces or radio interfaces.

In order to increase the transmission capacity for data transmission, two or more lines are frequently operated in parallel in modern communications systems. The data is subdivided for this purpose and is transmitted via appropriately bundled lines or physical connections. Methods relating to this for the transmission of corresponding data cells or data packets are generally known as IMA (Inverse Multiplexing) for ATM-Data transfer (ATM: Asynchronous Transfer Mode) or ML PPP (Multi Link Point to Point protocol) for IP data transfer (IP: Internet Protocol).

In these methods, the data flow is distributed between two or more physical lines. This has the disadvantage that serious faults occur as soon as only a single line in a corresponding line bundle becomes defective. In a corresponding manner, line failures must be detected, with appropriate measures being initiated, without delay in order to avoid a major loss of data. In the conventional methods for transmission of packet data or cell data via two or more physical lines, there are either no fault rectification mechanisms, for example in the case of ML PPP, or these mechanisms are very complex, as in the case of IMA for ATM data transmission. In the case of IMA, signaling messages are always passed via all the bundled lines. This results in a correspondingly large amount of data which has to be transmitted and processed overall for signaling messages. Furthermore, the design from the corresponding apparatus modules is very complex.

The normal physical layers or levels have corresponding identification mechanisms for identification of faults. After identification of a fault, appropriate messages can be transmitted to the central devices in the communications system, in response to which the central devices, for example an operation and maintenance center (OMC) can stop the distribution of the data via the faulty connections. Owing to the necessity to transmit appropriate messages and to process them, this procedure is complex and takes a relatively long time, during which data is still being sent to the defective physical connection.

### SUMMARY OF THE INVENTION

The invention introduces and simplifies a method for rectification of faults of physical connections in the case of bundled connections.

The detection of individual defective connections, or lines in a line bundle, even autonomously from one or both stations, at an interface offers a large number of advantages. There is no need for any complex signaling of an identified fault from the stations to one or more corresponding higher-level communications system devices, or only to signal a fault and to initiate the measures carried out by the station itself. In a corresponding manner, the signaling and administration complexity is reduced both for the interface-end stations that are involved and for the central devices. Furthermore, further use of the physical connection, which has been. identified in a corresponding manner as being defective, can be prevented as quickly as possible by means of the relevant interface-end stations Hence, it is possible to prevent further data from being sent on defective physical connections within a very short time, thus reducing the loss of data and/or the amount of data to be retransmitted. The remaining, sound physical connections in the bundle can still be used without the protocol collapsing, with physical connections which are still free being added to the bundle of connections, if any such physical connections are still free. While functions in the higher layers operate without influence, the functions in the lowermost layers thus ensure rapid and efficient fault handling.

### BRIEF DESCRIPTION OF THE DRAWINGS

An exemplary embodiment will be explained in more detail in the following text with reference to the drawings, in which:

FIG. 1 shows two communications systems with a connection between them.

FIG. 2 shows a diagram of the relevant protocol layers in the communications system apparatuses of FIG. 1.

### DETAILED DESCRIPTION OF THE INVENTION

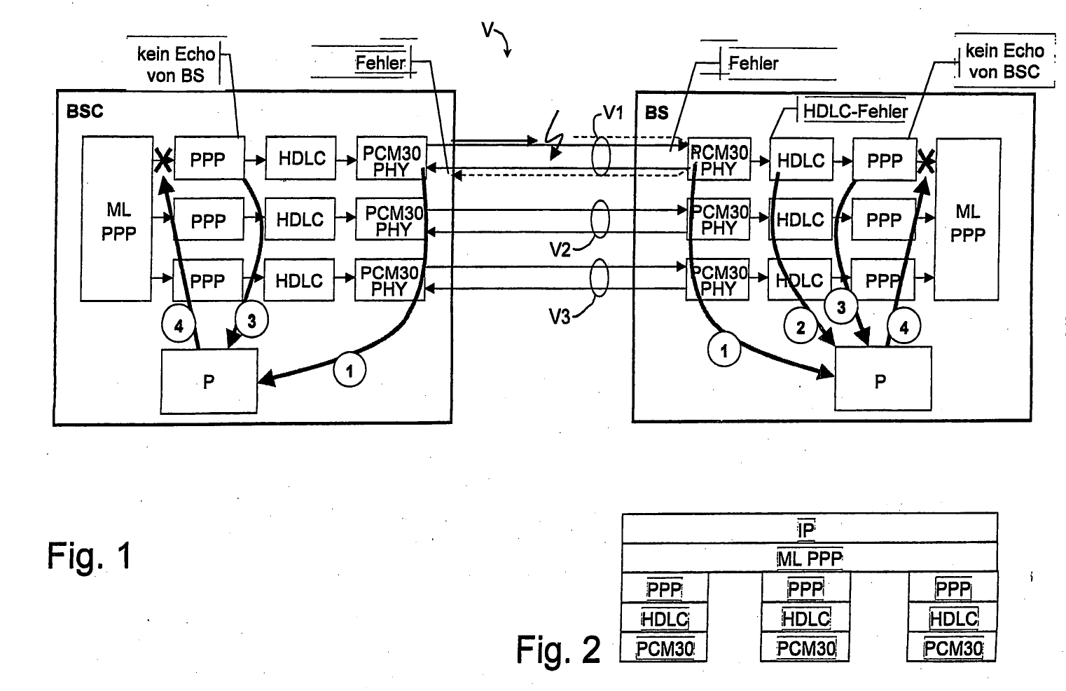

Referring to FIG. 1, there are interfaces V for the transmission of data and information between individual devices in a communications system, for example based on GSM. These interfaces may be either cable-based or else in the form of radio interfaces.

The two illustrated communications system apparatuses are, by way of example, a base station BS and a base station control device BSC, which interchange data and information with one another via the interface V. Further connections may exist between the stations or devices BSC, BS and further devices in the communications system GSM, but these are not illustrated, for simplicity. One such further device may, for example, be a higher-level control device, such as those which are known for comprehensive control in modern communications systems.

The two illustrated communications system apparatuses BSC, BS themselves each have a large number of devices for operation of the interface, with a proportion of these which are of particular interest in the following text once again being illustrated here. A processor P controls and administers corresponding devices and protocol layers, in particular including modules which are in the form of hardware and/or software.

In the illustrated exemplary embodiment, the interface V comprises three physical lines or interfaces, via which appropriate physical connections V1, V2 and V3 can be set up. In order to control and administer these individual physical lines, both communications system apparatuses BSC, BS have PCM30-PHY modules for administration of the physical layer or level PCM30 PHY. Each of these PCM30 modules for controlling and administering the physical level PCM30 PHY has a respectively associated HDLC module for delinearization of the packet to be transmitted (HDLC: High-Level Data Link Control). While the first-mentioned modules are generally associated with layer 1, the last-mentioned modules may be associated with layer 1 or even layer 2. HDLC modules each have associated PPP modules for controlling and administering point-to-point connections. These are generally associated with layer 2. The individual PPP modules for the individual connections V1-V3 have an associated higher-level ML PPP module, which splits the data between the various connections V1-V3 and administers data arriving via the various connections V1-V3. In particular, the data is distributed between the individual lines V1-V3 in this module.

Referring to FIG. 2, various protocol layers are thus administered in the two communications system apparatuses BSC BS, with the three lower elements PCM30, HDLC, PPP each being associated with one of the physical connections V1-V3, while the further elements ML PPP and, above it, IP are each associated with the interface V overall. The association of these individual elements with the various layers or levels is dependent on the respective communications system.

The following text describes the procedure for one preferred method for identification and handling of the faults of one or more physical connections (V1-V3 in the bundled interface V). The aim in this case is locally autonomous identification and handling of faults within each individual one of the communications system apparatuses BSC and BS between which the interface V exists.

In order to identify faults as quickly as possible, the fault identification process should be carried out at the. lowermost protocol layer (physical layer). Modern protocol layers/physical layers, such as the PCM30 (Pulse Code Modulation) or STM-1 (STM-1: Synchronous Transfer Mode), have appropriate fault identification mechanisms. These fault identification mechanisms allow a line fault on an individual physical line V1 to be identified virtually simultaneously and independently of one another in the corresponding communications system apparatuses BSC and BS on the two sides of the interface V. Identification of the line fault at both ends is particularly advantageous since, in the event of a defective line or connection V1, it is no longer possible to ensure that a communications apparatus BS which has identified the fault can still signal to the communications system apparatus at the other end of the transmission path or connection V that it has identified a fault. As already stated, in order to avoid this problem, the messages relating to this in the case of IMA are sent via all of the lines and connections V1-V3 which are involved in the bundle, although this contributes to the disadvantageously high degree of complexity of IMA, and is intended to be avoided here.

Additionally, or alternatively, protocols in layer 2 also in general offer a fault identification mechanism. In the case of PPP via HDLC, this is, for example, a checksum (HDLC checksum) and PPP echo messages. In the case of ATM, an HEC field (HEC: Header Error Checksum) is provided in a corresponding manner in the ATM cells.

Both of the fault identification mechanisms described above are available independently of one another in the communications system apparatuses, with fault identification systems each detecting and signaling faults relating to a single line V1. Fault messages such as these are used in the method that is described in the following text.

After detection and signaling of a fault on one of the lines or connections V1, the respective connection is removed from the bundle of lines or connections V1-V3 by the protocol layer which combines the physical lines, for example, IMA or ATM or, as illustrated, ML PPP in the case of IP data transmission. This ensures that no data is transmitted via the faulty line or connection V1, which would result in the entire data transmission being corrupted. According to the simplest embodiment, the overall data rate of the bundle of connections V1-V3 is, of course, reduced in this case.

If additional lines or connections V are free or are unused, a line such as this can also be included in the remaining bundle V2, V3 as an additional line or as a replacement line. An additional line such as this may, for example, be a line which can be configured as an unused line for redundancy reasons while the interface V is being configured for a specific data transmission. The inclusion of a line such as this allows the bundle of lines to maintain or recover the original data rate.

The configuration which is illustrated in FIG. 1 is used as a particularly preferred exemplary embodiment. This is a multiple connection point-to-point connection (ML PPP connection) via two or more (three in the case of the present exemplary embodiment) PCM30 lines or connections V1-V3 as are frequently used for the transmission of IP data. After the occurrence of a fault on the first line or connection, V1, this fault is simultaneously identified by the PCM30 fault identification mechanisms in the PCM30-PHY module at both ends of the line V1, preferably in both communications system apparatuses BSC and BS, and is signaled via an appropriate connection to the processor P (1).

At the receiver end, preferably by way of example the base station BS, the HDLC module which is associated with the defective line V1 also identifies an HDLC fault, and this is signaled via an appropriate line to the associated processor P in the base station BS (2).

Furthermore, PPP echo notification or messages which the transmitter-end station, in the present case the base station control device BSC, transmits regularly do not arrive at the receiver-end station BS which is once again detected with the aid of the PPP module, with an appropriate message being passed by an appropriate connection to the processor P. Owing to the lack of any PPP echo notification, the base station BS in a corresponding manner does not send back any echo either, and this is in turn detected by the PPP module in the base station control device BSC. An appropriate fault message is signaled via an appropriate connection to the processor P in the base station control device BSC.

As stated above, it is possible to use a large number of fault detection and fault signaling systems, which detect a fault on an individual line or connection V1 and signaling to the associated processor P in the respective communications system apparatus BSC or BS. In theory, even just one of these various fault detection devices is sufficient to carry out the method described here.

The processor P, in each case, receives the locally determined fault, that is the fault determined in its communications system apparatus BSC or BS, and carries out an appropriate fault action, or causes the corresponding further devices among the communications apparatuses BSC or BS to carry out an appropriate fault action. In the present case, if a connection V1 is faulty, the line or connection V1 is locally and autonomously removed from the ML PPP bundle V1-V3 after appropriate signaling 1-3 to the processor P (4). In consequence, transmission faults from the faulty connection V1 can no longer have any negative effect on the transmission quality of the remaining overall bundle V2-V3.

Expediently, although this is not necessarily essential, an appropriate message about the removal of the connection V1 from the bundle of connections V1-V3 can be transmitted from the processor P to another instance or device, particularly at a higher level, in the communications system, in order to make it possible to take account of an appropriate action in the communications system. This includes, in particular, messages to an operator or to a maintenance center. However, it is also possible to send a message to the remote communications system apparatus which communicates via the interface V, in order to make it possible to coordinate further measures at a higher level.

In particular, control by the processor P is also advantageous in that it allows the addition of a further previously unused line or connection to the remaining bundle of connections V2, V3. According to one particularly simple embodiment, the connection to be added may be a line which has already previously been reserved for purposes such as this. However, according to more complex embodiments, any other desired line may be added to the bundle, with appropriate signaling for matching the remote end to the interface V having to be carried out in this case via, for example, the line or connection that is to be added.

What is claimed is:

1. A method for rectification of faults for failure of individual physical connections in communication connections having two or more physical connections between at least two communications system apparatuses, comprising:
transmitting data via at least two of the physical connections;
monitoring the connections in the communications system apparatus for the occurrence of faults and/or failures; and
deactivating, in the event of a connection fault or failure, the faulty connection or faulty connections, wherein
in the event of a connection fault or failure in the at least two communications system apparatuses, no data is transmitted from higher layers via the faulty physical connection or connections, with the faulty connection being deactivated without any deactivation-related protocol interchange between the communications system apparatuses

2. The method as claimed in claim 1, wherein sound connections are used for transmission of the data without any change to the general procedure relating to this.

3. The method as claimed in claim 1, wherein the faulty connections are deactivated within at least one of the communications system apparatuses.

4. The method as claimed in claim 1, further comprising detecting a connection fault at the physical level, and no data is transmitted via the faulty physical connection.

5. The method as claimed in claim 1, further comprising detecting a connection fault at the protocol level, and no data is transmitted via the faulty physical connection.

6. The method as claimed in claim 1, further comprising a connection fault at the lowermost protocol level, and no data is transmitted via the faulty physical connection.

7. A communications system apparatus comprising:
an interface with a plurality of physical lines for setting up physical data connections to at least one other communications system apparatus which is connected via the interface;
a processor in the communications system apparatus for controlling and administering the interface and the data connections with data being transmitted subdivided between two or more of the data connections;
a monitoring device for monitoring the data connections wherein
the processor is configured to rectify faults for failure of individual physical connections in communication connections having two or more physical connections between at least two communications system apparatuses and for autonomous deactivation of individual data connections or all of the data connections after detection of a corresponding fault by means of the corresponding monitoring device.
